(19) United States
(12) Patent Application Publication
(10) Pub. No.: US 2017/0142155 A1
(43) Pub. Date: May 18, 2017

(54) Advanced Local-Network Threat Response

(71) Applicant: F-Secure Corporation, Helsinki (FI)

(72) Inventors: Leszek TASIEMSKI, Poznan (PL); Marko FINNIG, Helsinki (FI); Ville Kurkinen, Espoo (FI); Szymon GRZYBOWSKI, Poznan (PL); Tomasz LIPERT, Kolaczkowo (PL)

(73) Assignee: F-Secure Corporation

(21) Appl. No.: 15/345,710

(22) Filed: Nov. 8, 2016

(30) Foreign Application Priority Data
Nov. 12, 2015 (GB) 1519972.2

(51) Int. Cl. H04L 29/06

(52) U.S. Cl. CPC H04L 63/1491; H04L 63/1416

(57) ABSTRACT

There are provided measures for enabling advanced local-network threat response. Such measures could exemplarily include detecting a security threat initiated by a local-network host at a local-network honeypot entity, triggering a threat response operation at a local-network backend entity upon detection of the security threat by the local-network honeypot entity, and executing the threat response operation by the local-network backend entity, said threat response operation including an operation of one of an endpoint threat management system and a local-network vulnerability management system.

### FIELD

The present invention relates to advanced local-network threat response. More specifically, the present invention relates to measures (including methods, apparatuses and computer program products) for enabling advanced local-network threat response.

### BACKGROUND

In modern communication networks, security is a vital issue, and attacks on network security tend to be increasing in terms of both number and complexity. Accordingly, appropriately responding to such security threats is paramount in modern communication networks.

Various types of systems are known for realizing a response to such security threats, which are specifically designed for specific purposes or circumstances. Among these, the following systems shall be briefly mentioned.

Firstly, honeypot systems are known, in which a (allegedly) less-secured honeypot entity is provided so as to attract attacks. Such honeypot entity is or runs on a host (oftentimes in a lightweight implementation lacking certain capabilities of actual hosts) which appears to be part of a local network, but is isolated from actual hosts of the local network. That is, such honeypot entity is specifically dedicated to attract attacks, but usually does not have sufficient information for taking appropriate measure, thus failing to provide for suitable mechanisms to appropriately responding to such security threats, e.g. in a sufficiently fast and efficient manner. Further, honeypot systems are not able to respond to security threats with respect to their honeypot entity, and

Secondly, endpoint threat detection systems are known, in which an endpoint agent is installed on hosts in a local network so as to monitor their behavior and, where appropriate, retrieve relevant security-related information from the hosts, e.g. to a backend entity. Based on such information, any host or any process thereof can be blocked or isolated in order to ensure security in response to a security threat. Yet, such systems do not always detect new security threats within a local network, particularly because of being limited to monitoring those hosts registered in the endpoint threat detection system.

Thirdly, local-network vulnerability management systems are known, in which a backend entity performs vulnerability scans of hosts in the local network, writes any detected vulnerabilities in a vulnerability management database and, upon demand, reads such vulnerabilities from the vulnerability management database. Such vulnerability scanning and management mechanism is well suited for network administrators or analysts to get an overview of the overall security situation in their local network. Yet, such systems are typically not able to timely respond to new security threats, thus failing to appropriately respond to security threats, e.g. in a sufficiently fast and efficient manner.

Accordingly, it is evident that available systems for responding to security threats suffer from various drawbacks, and it is thus desirable to improve security threat response so as to overcome such drawbacks.

### SUMMARY

Various exemplifying embodiments of the present invention aim at addressing at least part of the above issues and/or problems.

Various aspects of exemplifying embodiments of the present invention are set out in the appended claims.

According to an example aspect of the present invention, there is provided a method of local-network threat response, the method comprising: detecting a security threat initiated by a local-network host at a local-network honeypot entity, triggering a threat response operation at a local-network backend entity upon detection of the security threat by the local-network honeypot entity, and executing the threat response operation by the local-network backend entity, said threat response operation including an operation of one of an endpoint threat management system and a local-network vulnerability management system.

According to an example aspect of the present invention, there is provided an apparatus, comprising a memory configured to store computer program code, and a processor configured to read and execute computer program code stored in the memory, wherein the processor is configured to cause the apparatus to perform: detecting a security threat initiated by a local-network host at a local-network honeypot entity, triggering a threat response operation at a local-network backend entity upon detection of the security threat by the local-network honeypot entity, and executing the threat response operation by the local-network backend entity, said threat response operation including an operation of one of an endpoint threat management system and a local-network vulnerability management system.

According to an example aspect of the present invention, there is provided an apparatus, comprising means for detecting a security threat initiated by a local-network host at a local-network honeypot entity, means for triggering a threat response operation at a local-network backend entity upon detection of the security threat by the local-network honeypot entity, and means for executing the threat response operation by the local-network backend entity, said threat response operation including an operation of one of an endpoint threat management system and a local-network vulnerability management system.

According to further developments and/or modifications of any one of the aforementioned example aspects of the present invention, for example, one or more of the following can apply:

the detecting may comprise identifying an abnormal local-network activity, and identifying the IP address of the local-network host initiating the identified abnormal local-network activity,

the triggering may comprise transferring information on at least the IP address of the local-network host initiating the detected security threat from the local-network honeypot entity to the local-network backend entity,

the executing may comprise determining whether the local-network host initiating the detected security threat is registered in the endpoint threat management system, and executing the operation of the endpoint threat management system if the local-network host is determined to be registered in the endpoint threat management system, or executing the operation of the local-network vulnerability management system if the local-network host is determined not to be registered in the endpoint threat management system,

the operation of the endpoint threat management system may comprise causing information retrieval for retrieving information for the local-network host by activating a check and/or extraction by an endpoint agent installed on the local-network host,

the operation of the local-network vulnerability management system may comprise causing information retrieval for retrieving information for the local-network host by performing a lookup from a local-network vulnerability database,

the operation of the local-network vulnerability management system may comprise causing information retrieval for retrieving information for the local-network host by performing a scan of the local-network host,

the operation of the endpoint threat management system may comprise blocking or isolating the local-network host on local-network level, and/or blocking or isolating at least one process of the local-network host relating to the detected security threat.

According to an example aspect of the present invention, there is provided a computer program product, comprising computer-executable computer program code which, when the computer program code is executed on a computer, is configured to cause the computer to carry out a method according to the aforementioned method-related example aspect of the present invention, including any developments and/or a modifications thereof.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

Further developments and/or modifications of the aforementioned example aspects of the present invention are set out herein with reference to the drawings and exemplifying embodiments of the present invention.

By way of exemplifying embodiments of the present invention, realization of an advanced local-network threat response is enabled, which is capable of provide for both high speed and efficiency for responding to a security threat in a local network.

### BRIEF DESCRIPTION OF THE DRAWINGS

In the following, the present invention will be described in greater detail by way of non-limiting examples with reference to the accompanying drawings, in which

FIG. 1 shows a schematic diagram illustrating a system configuration underlying exemplifying embodiments of the present invention,

FIG. 2 shows a diagram illustrating an example of a procedure for realizing an advanced local-network threat response according to exemplifying embodiments of the present invention,

FIG. 3 shows a flowchart illustrating an example of a method, operable at a local-network backend entity, according to exemplifying embodiments of the present invention,

FIG. 4 shows a diagram illustrating an example of a process flow for realizing an advanced local-network threat response according to exemplifying embodiments of the present invention, and

FIG. 5 shows a schematic diagram illustrating an example of a structure of an apparatus according to exemplifying embodiments of the present invention.

### DETAILED DESCRIPTION

The present invention is described herein with reference to particular non-limiting examples and to what are presently considered to be conceivable embodiments of the present invention. A person skilled in the art will appreciate that the present invention is by no means limited to these examples, and may be more broadly applied.

Hereinafter, various exemplifying embodiments and implementations of the present invention and its aspects are described using several variants and/or alternatives. It is generally noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is noted that lines/arrows interconnecting individual blocks or entities are generally meant to illustrate an operational coupling therebetween, which may be a physical and/or logical coupling, which on the one hand is implementation-independent (e.g. wired or wireless) and on the other hand may also comprise an arbitrary number of intermediary functional blocks or entities not shown.

According to exemplifying embodiments of the present invention, in general terms, there are provided measures and mechanisms for enabling dynamic remote malware scanning, as described in more details below.

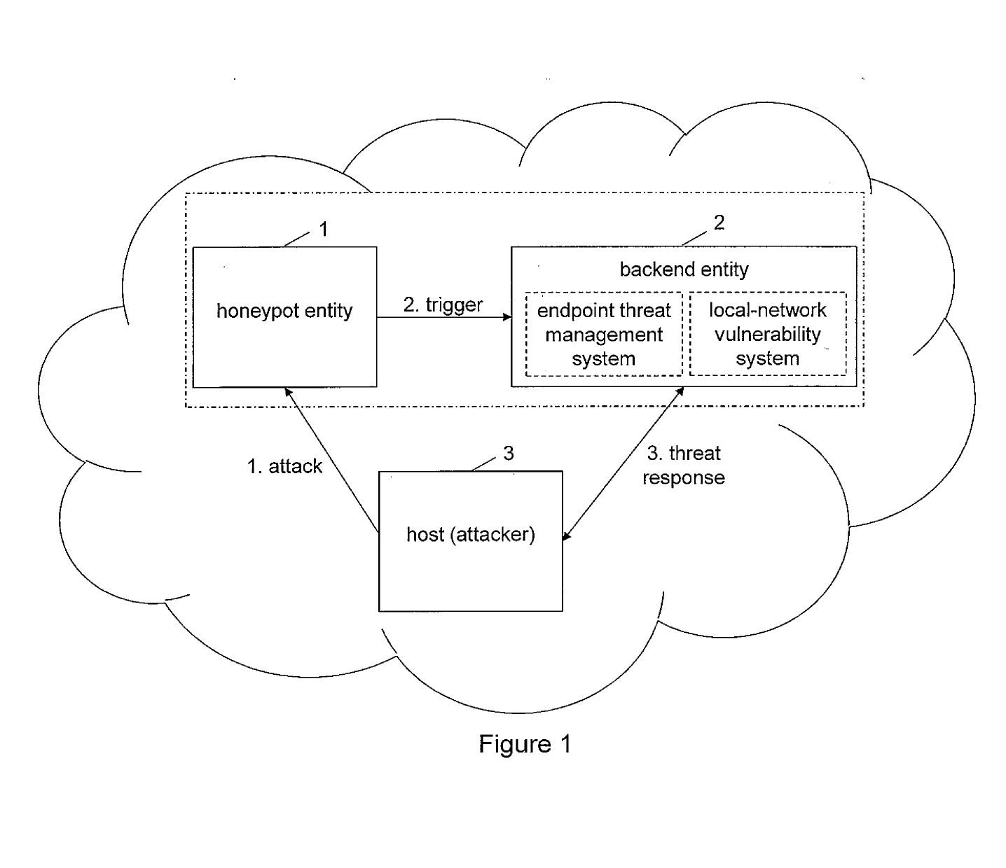

FIG. 1 shows a schematic diagram illustrating a system configuration underlying exemplifying embodiments of the present invention.

As shown in FIG. 1, exemplifying embodiments of the present invention are generally based on a system configuration in which a local network, i.e. a network of a local domain (behind a firewall or the like), comprises at least one honeypot entity 1, at least one backend entity 2, and at least one host 3, such as a workstation or the like (generally, any type of endpoint can be a host here, including laptops, desktops, mobiles, servers, or the like). It is assumed that the host 3 represents an attacker attacking the honeypot entity 1.

The local network may be any kind of communication network, such as any kind of IP-based network (IP: Internet Protocol). Any one of the honeypot entity 1, the backend entity 2 and the host 3 may be implemented by means of hardware (e.g. as a dedicated node or part of a node) and/or software (e.g. as a program or process running on any hardware).

As indicated by a dash-dotted box, a system according to exemplifying embodiments of the present invention may comprise at least one honeypot entity and at least one backend entity (either one of these being implemented in hardware and/or software). In such system, one or more honeypot entities and one or more backend entity may be implanted in the same or distinct hardware instances such as nodes or workstations.

As indicated by dashed boxes, a backend entity may structurally or functionally encompass an endpoint threat management system and a local-network vulnerability management system. That is, a backend entity may be operable as, for or within an endpoint threat management system and a local-network vulnerability management system.

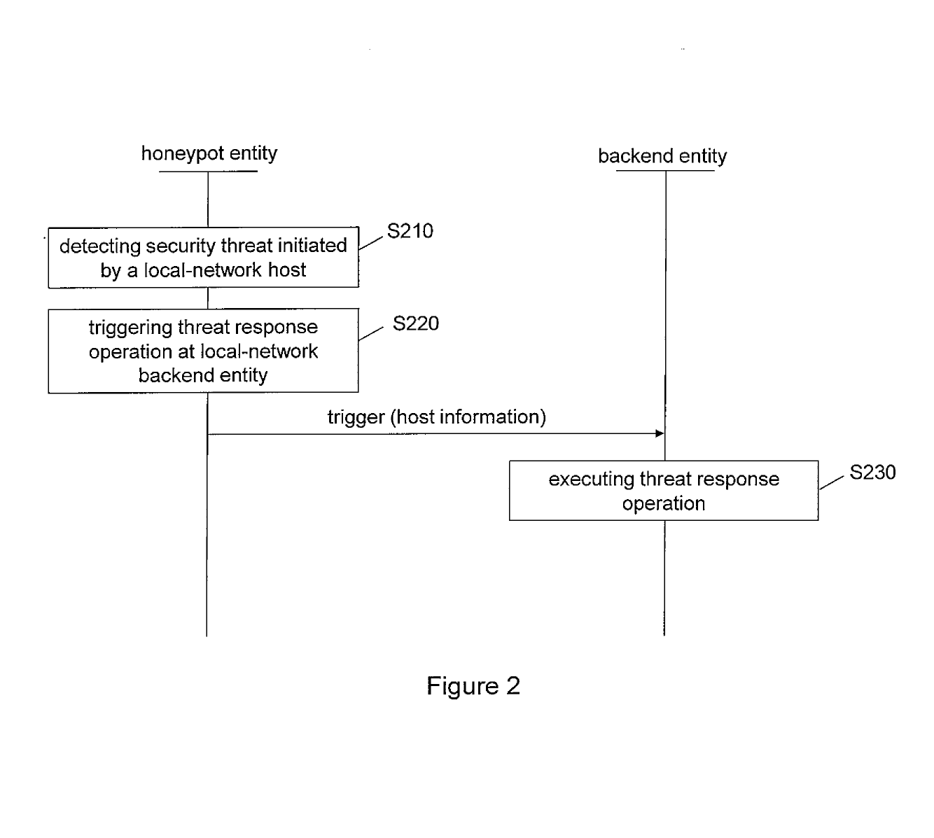

As shown in FIG. 1, exemplifying embodiments of the present invention are generally based on an operational sequence of an attack (i.e. a security threat) which is initiated by the local-network host against the local-network honeypot entity, a threat response trigger from the local-network honeypot entity to the local-network backend entity, and a threat response operation by the local-network backend entity (acting towards the local-network host). Details of such operational sequence are described below with reference to FIGS. 2 to 4.

FIG. 2 shows a diagram illustrating an example of a procedure for realizing an advanced local-network threat response according to exemplifying embodiments of the present invention. As shown in FIG. 2, a procedure for realizing an advanced local-network threat response according to exemplifying embodiments of the present invention comprises various operations at a local-network honeypot entity and a local-network backend entity as illustrated in FIG. 1.

Specifically, the honeypot entity detects a security threat initiated by the host (S210), and triggers a threat response operation at the backend entity upon detection of the security threat (S220). For triggering, the honeypot entity generates and transmits a corresponding trigger, which may be based on a related event being produced by detection of the security threat at the honeypot entity. The thus transmitted trigger comprises or is accompanied by host information. That is, together with the trigger, information on at least a network address, such as the IP address, of the host initiating the detected security threat is transferred from the honeypot entity to the backend entity.

For example, detection of the security threat at the honeypot entity may comprise identification of an abnormal local-network activity, and identification of a network address, such as the IP address, of the host initiating the identified abnormal local-network activity. Based on such identification, the identified abnormal local-network activity can be flagged as dangerous, i.e. a (potential) security threat. Any information identified in this regard may be transferred as (part of) host information together with the trigger, as described above.

An abnormal local-network activity, which can be identified as a security threat, may be any network activity which should not occur in a normal network operation under normal network conditions (wherein normal network operation under normal network conditions can be defined in advance, e.g. in an associated knowledge base of the honeypot entity or a related database). Such abnormal local-network activity may include e.g. predefined connection establishment, predefined authentication attempt, malware upload or installation, or the like. For example, an abnormal local-network activity when a request for or establishment of an SSH outbound connection (SSH: Secure Shell) with the honeypot entity as one end is identified, since this would be an unusual activity (as compared with a request for or establishment of an SSH outbound connection with any actual hosts or workstations as the ends).

Based on (receipt of) the trigger from the honeypot entity, the backend entity executes a corresponding threat response operation (S230). Such threat response operation is based on the host information transferred together with the trigger, and includes an operation of one of an endpoint threat management system and a local-network vulnerability management system.

Although not shown, the backend entity may then generate a report (threat response report) using any information retrieved in the course of the threat response operation, as exemplified below.

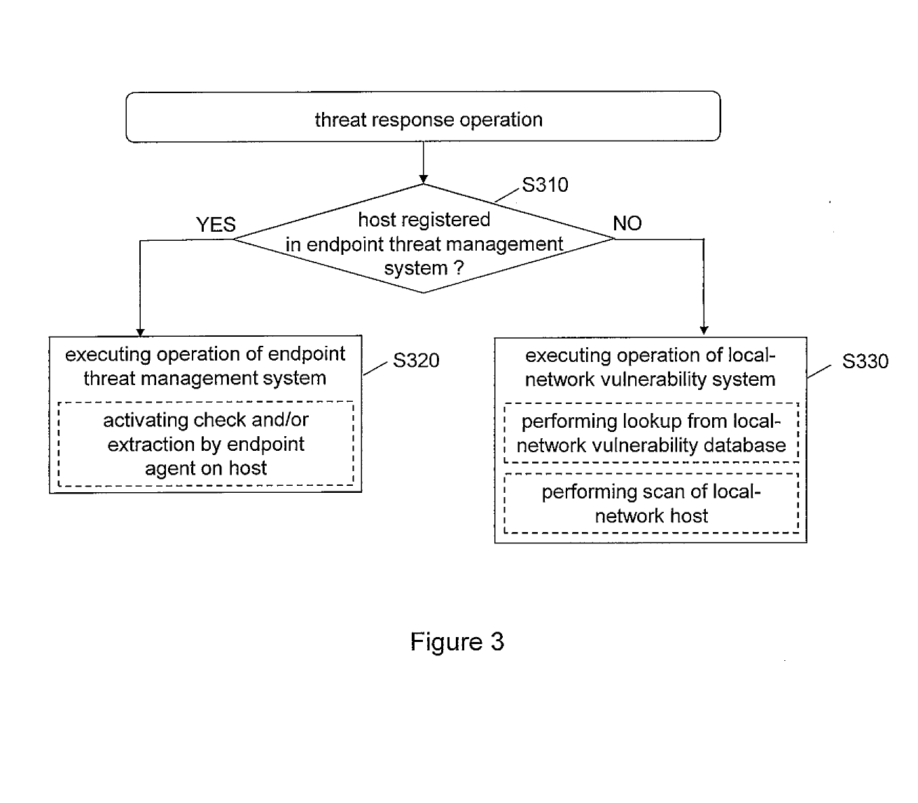

FIG. 3 shows a flowchart illustrating an example of a method, operable at a local-network backend entity, according to exemplifying embodiments of the present invention. As shown in FIG. 3, a method for executing a threat response operation (like in S230 in FIG. 2) according to exemplifying embodiments of the present invention comprises various operations at a local-network backend entity as illustrated in FIG. 1.

Specifically, the backend entity determines whether the host initiating the detected security threat (i.e. the host corresponding to the transferred host information) is registered in the endpoint threat management system (S310).

Such determination can be based on a previously prepared or predefined host or workstation list of the endpoint threat management system. In such host or workstation list, all of those hosts in the local network can be registered, on which an endpoint agent (i.e. a program or routine of the endpoint threat management system running on the host) is installed. That is, the host can be determined to be registered in the endpoint threat management system when an endpoint agent is installed thereon (and the host is registered in a corresponding list accordingly).

If the backend entity determines the host to be registered in the endpoint threat management system (YES in S310), the backend entity executes the operation of the endpoint threat management system (S320). Otherwise, if the backend entity determines the host not to be registered in the endpoint threat management system (NO in S310), the backend entity executes the operation of the local-network vulnerability management system (S330).

The operation of the endpoint threat management system (S320) is executed between the backend entity and the endpoint agent installed on the host. Such operation basically causes information retrieval for retrieving information for the host by activating a check and/or extraction by the endpoint agent installed on the host. That is, a deep scan and/or an extraction of artifacts for forensic investigation can be initiated at the host by use of the endpoint agent installed on the host. Thereby, various information can be retrieved, which are useful for the further threat response operation, including e.g. information on properties of the host, information on properties of the detected security threat, or the like. For example, such information may include or relate to least one memory dump, at least one file hash, at least one meta information on ongoing processes and/or connections, at least one copy of a binary, and at least one network interface data dump.

The operation of the local-network vulnerability management system (S330) can be executed between the backend entity and a local-network vulnerability database or between the backend entity and the host itself. These cases can be differentiated based on a previously prepared or predefined database of the local-network vulnerability management system. In such local-network vulnerability management database, the results of previous vulnerability scans of the local network are registered. Such results may include e.g. opened port/s, ongoing service/s, system version/s, one or more security vulnerabilities of any previously (recently) scanned local-network host. Namely, if the host corresponding to the transferred host information is registered in the vulnerability management database, the operation of the local-network vulnerability management system can be executed by a vulnerability lookup, i.e. between the backend entity and the vulnerability database. Otherwise, the host corresponding to the transferred host information is not registered in the vulnerability management database, the operation of the local-network vulnerability management system can be executed by a vulnerability scan, i.e. between the backend entity and the host itself.

In the former case, such operation basically causes information retrieval for retrieving information for the host by performing a lookup from the local-network vulnerability database. In the latter case, such operation basically causes information retrieval for retrieving information for the host by performing a scan of the host. In any case, various information can be retrieved, which are useful for the further threat response operation, including e.g. information on properties of the host, information on properties of the detected security threat, or the like. For example, such information may include or relate to e.g. opened port/s, ongoing service/s, system version/s, one or more security vulnerabilities of any previously (recently) scanned local-network host.

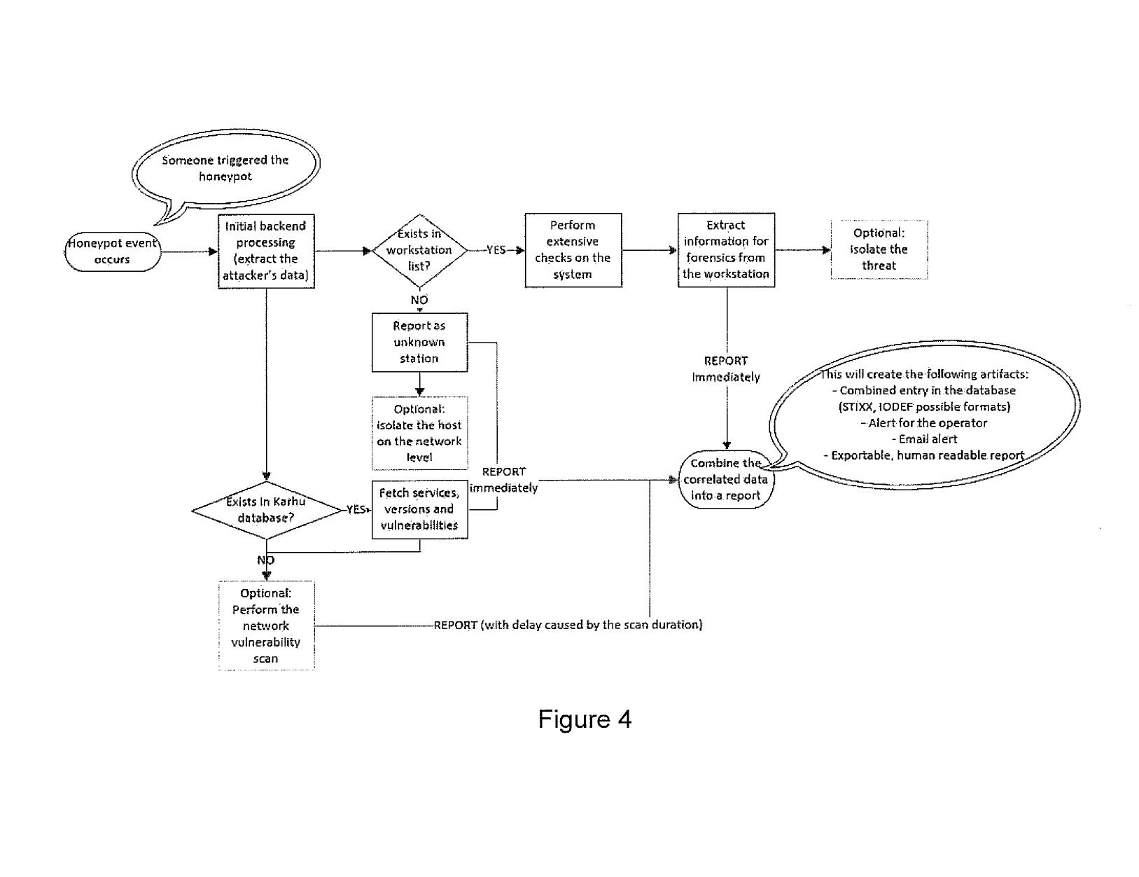

FIG. 4 shows a diagram illustrating an example of a process flow for realizing an advanced local-network threat response according to exemplifying embodiments of the present invention. The process flow in FIG. 4 is exemplified for a system in which the local-network vulnerability system is implemented by a software platform called KARHU, which is a proprietary vulnerability management tool of F-Secure Corporation.

As shown in FIG. 4, a honeypot event occurs (or. stated in other words, the honeypot is triggered) when an attack, i.e. a security threat, is detected at the honeypot entity. Based thereon, the honeypot entity issues a corresponding event and data as a detection trigger to the backend entity. At the backend entity, in an initial backend processing, the source of the attack (e.g. the IP address thereof) is extracted from the transferred host information. Based on thus extracted source/host information, the database of the endpoint threat management system (i.e. the database of registered endpoint workstations, or the list of hosts with installed endpoint agent within the local network), and/or the database of the local-network vulnerability management system (i.e. the database of previous vulnerability scans, or the list of hosts with known vulnerabilities within the local network) can be checked. That is, both available databases can be checked in parallel. To this end, the IP address of the attacking host can be used.

In case the attacking host is registered in the database of the endpoint threat management system (referred to as the workstation list in FIG. 4), the operation of the endpoint threat management system is initiated automatically and instantaneously, as indicated in S320 in FIG. 3. In this regard, with the help of the endpoint agent installed on the host, extensive checks on the host/system are performed and information for forensic investigation is extracted from the host/workstation. Also, information can be retrieved, which is stored foe the host in the database as such meta information like owner, last seen timestamp, etc. The thus retrieved information can be used to generate and issue a corresponding report (or part thereof). Optionally, the threat can be isolated, That is, at least one process of the attacking host relating to the detected attacked can be blocked or isolated.

In case the attacking host is not registered in the database of the endpoint threat management system (referred to as the workstation list in FIG. 4), the host is determined as being unknown for the endpoint threat management system, and a corresponding report (or part thereof) can be generated and issued automatically and instantaneously. Optionally, the host can be isolated. That is, the attacking host can be blocked or isolated on network level.

In case the attacking host is registered in the database of the local-network vulnerability management system (referred to as the Karhu database in FIG. 4), the vulnerability lookup operation of the local-network vulnerability management system is initiated automatically and instantaneously, as indicated in S330 in FIG. 3. In this regard, the Karhu database will be checked of any scans of the host, and all known opened ports (services); etc. will be reported along with identified vulnerabilities. For example, any services, versions and vulnerabilities of the host are fetched from the database. The thus retrieved information can be used to generate and issue a corresponding report (or part thereof).

In case the attacking host is not registered in the database of the local-network vulnerability management system (referred to as the Karhu database in FIG. 4), the vulnerability scan operation of the local-network vulnerability management system can be initiated automatically and instantaneously, as indicated in S330 in FIG. 3. In this regard, a network vulnerability scan can be performed using the local-network vulnerability management system. The thus retrieved information can be used to generate and issue a corresponding report (or part thereof).

In all cases, even if the source of the attack is unknown to both databases of the two parallel systems, a network vulnerability scan using the local-network vulnerability management system can be performed on the attacking host, and current information of the host and the attack can thus be retrieved in real time.

As evident from the process flow of FIG. 4, a combined report can be generated and issued, which comprises information retrieved by/in the endpoint threat management system and information retrieved by/in local-network vulnerability management system. Such report can show that some threat response operation is or will be initiated, and/or prompt a user to carry our certain measures or actions. For example, such report can contain artifacts such as ones based on STIXX (Structured Threat Information Expression), IODEF (Incident Object Description. Exchange Format), or the like.

In principle, such combined report may for example be one of the following.

“The honeypot detected an attack from the <IP> workstation which is a known registered host, automated memory dump was executed and extracted to backend for investigation. Deep local scan was initiated and 3 suspicious binaries were secured and delivered for detail malware analysis.”

“The honeypot detected an attack from the <IP> host which is not a registered workstation. The host is known to Karhu (last scanned at TIMESTAMP), this host is likely a CentOS Linux which is running Apache server on port TCP/80. The service contains 3 high level vulnerabilities (CVE-XXXX, CVE-XXXX, CVE-XXXX), which were likely the entry vector for compromising the host. Please, initiate the forensics investigation manually.”

As indicated above, CVE® (Common Vulnerabilities and Exposures) can be used to identify the recognized vulnerabilities. Namely, CVE is a dictionary of publicly known information security vulnerabilities and exposures, and CVE's common identifiers enable data exchange between security products and provide a baseline index point for evaluating coverage of tools and services.

In brief, the process according to exemplifying embodiments of the present invention is based on the principle to utilize both honeypot entities (i.e. lightweight hosts pretending to be weak in terms of security protection), which are used as detection triggers for attacks, and parallel threat management systems, i.e. the presence of endpoint agents installed on hosts in the network and the presence of a network vulnerability facility in the network. If the attacking host is a host with endpoint agent installed thereon, deep scan and extraction artifacts for forensic investigation can be automatically triggered. Otherwise, if the attacking host is not a host with endpoint agent installed thereon, a network-internal vulnerability lookup (e.g. the Karhu database) is used to discover more information about the attacking host (which has already been retrieved by previous scan/s). Even if the attacking host is not yet known in any one of the parallel threat management systems, the network-internal vulnerability scanner (e.g. the Karhu scanner) can be used to initiate a scan against the offending IP address to discover more information about the attacking host. Thereby, automatic and instantaneous evidence collection is enabled in all cases.

By virtue of exemplifying embodiments of the present invention, as described above, an advanced local-network threat response is enabled, which is capable of provide for both high speed and efficiency for responding to a security threat in a local network.

Namely, the technique according to exemplifying embodiments of the present invention enables that the effect of an attack can be reliably recognized and responded to automatically and instantaneously. In this regard, it is beneficial that a honeypot entity is used as a detection trigger for attacks, as such attacks to a honeypot entity (which is specifically dedicated to attract attacks) would otherwise be missed when focusing on threat response operation by using the parallel threat management systems in the local network only. For example, a single SSH outbound connection would usually not be flagged as dangerous, but it can be identified as an attack when recognizing that the other end is a honeypot entity. In this case, by utilizing an endpoint agent installed on the attacking host, deep scan and forensic artefact collection (e.g. extract memory dump, meta information about processes, network traffic dump, etc.) can be immediately and automatically initiated. Similar information collection can equally be initiated immediately and automatically via the vulnerability management system as well. Namely, a respective database search and/or active scan against the attacking host is triggered automatically and immediately. So, a high speed of threat response and automatic evidence gathering (with high accuracy) can be achieved.

Accordingly, the technique according to the technique according to exemplifying embodiments of the present invention saves time and gives network administrators or analysts far more detailed and instant information about both the attack and the attacking host than in any conventional technique. This technique further limits the amount of manpower needed to monitor the security of a network and to perform the initial classification of the attack. As outlined above, most of the process can be done fully automatically with.

The above-described methods, procedures and functions may be implemented by respective functional elements, entities, modules, units, processors, or the like, as described below.

While in the foregoing exemplifying embodiments of the present invention are described mainly with reference to methods, procedures and functions, corresponding exemplifying embodiments of the present invention also cover respective apparatuses, entities, modules, units, nodes and systems, including both software and/or hardware thereof.

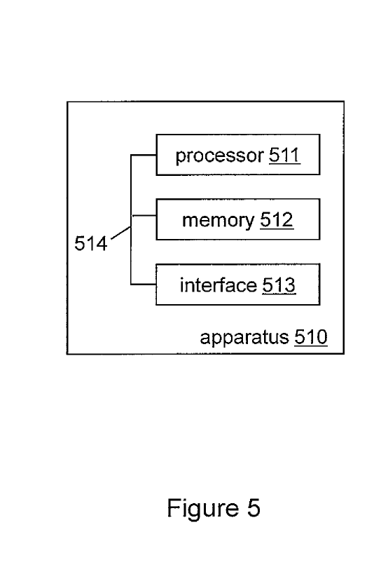

Respective exemplifying embodiments of the present invention are described below referring to FIG. 5, while for the sake of brevity reference is made to the detailed description of respective corresponding configurations/setups, schemes, methods and functionality, principles and operations according to FIGS. 1 to 4.

In FIG. 5, the solid line blocks are basically configured to perform respective methods, procedures and/or functions as described above. The entirety of solid line blocks are basically configured to perform the methods, procedures and/or functions as described above, respectively. With respect to FIG. 5, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIG. 5, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories, a display, or the like. Among others, one or more memories are provided for storing programs or program instructions for controlling or enabling the individual functional entities or any combination thereof to operate as described herein in relation to exemplifying embodiments.

In general terms, respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the thus illustrated devices/apparatuses are suitable for use in practicing one or more of the exemplifying embodiments of the present invention, as described herein.

FIG. 5 shows a schematic diagram illustrating an example of a structure of an apparatus according to exemplifying embodiments of the present invention.

As indicated in FIG. 5, an apparatus 510 according to exemplifying embodiments of the present invention may comprise at least one processor 511 and at least one memory 512 (and possibly also at least one interface 513), which may be operationally connected or coupled, for example by a bus 514 or the like, respectively.

The processor 511 of the apparatus 510 is configured to read and execute computer program code stored in the memory 512. The processor may be represented by a CPU (Central Processing Unit), a MPU (Micro Processor Unit), etc, or a combination thereof. The memory 512 of the apparatus 510 is configured to store computer program code, such as respective programs, computer/processor-executable instructions, macros or applets, etc. or parts of them. Such computer program code, when executed by the processor 511, enables the apparatus 510 to operate in accordance with exemplifying embodiments of the present invention. The memory 512 may be represented by a RAM (Random Access Memory), a ROM (Read Only Memory), a hard disk, a secondary storage device, etc., or a combination of two or more of theses. The interface 513 of the apparatus 510 is configured to interface with another apparatus and/or the user of the apparatus 610. That is, the interface 513 may represent a communication interface (including e.g. a modem, an antenna, a transmitter, a receiver, a transceiver, or the like) and/or a user interface (such as a display, touch screen, keyboard, mouse, signal light, loudspeaker, or the like).

The apparatus 510 may, for example, represent a (part of a) system, such as the combination of the host entity 1 and the backend entity 2 in FIG. 1 (as indicated by the dash-dotted box), or may represent a (part of a) the host entity 1 in FIG. 1, or may represent a (part of a) the backend entity 2 in FIG. 1. The apparatus 510 may be configured to perform a procedure and/or exhibit a functionality as described in any one of FIGS. 2 to 4.

When representing the (a part of the) system, the apparatus 510 or its processor 511 (possibly together with computer program code stored in the memory 512), in its most basic form, is configured to detect a security threat initiated by a local-network host at a local-network honeypot entity, to trigger a threat response operation at a local-network backend entity upon detection of the security threat by the local-network honeypot entity, and to execute the threat response operation by the local-network backend entity, said threat response operation including an operation of one of an endpoint threat management system and a local-network vulnerability management system.

When representing the (a part of the) honeypot entity, the apparatus 510 or its processor 511 (possibly together with computer program code stored in the memory 512), in its most basic form, is configured to detect a security threat initiated by a local-network host, and to trigger a threat response operation at a local-network backend entity upon detection of the security threat.

When representing the (a part of the) backend entity, the apparatus 510 or its processor 511 (possibly together with computer program code stored in the memory 512), in its most basic form, is configured to receive a trigger for a threat response operation from a local-network honeypot entity (for responding to a security threat initiated by a local-network host at the local-network honeypot entity), and to execute the threat response operation, said threat response operation including an operation of one of an endpoint threat management system and a local-network vulnerability management system.

Accordingly, any one of the above-described schemes, methods, procedures, principles and operations may be realized in a computer-implemented manner.

Any apparatus according to exemplifying embodiments of the present invention may be structured by comprising respective units or means for performing corresponding operations, procedures and/or functions. For example, such means may be implemented/realized on the basis of an apparatus structure, as exemplified in FIG. 5 above, i.e. by one or more processors 511, one or more memories 512, one or more interfaces 513, or any combination thereof.

An apparatus according to exemplifying embodiments of the present invention, which represents the (a part of the) system, may comprise (at least) a unit or means for detecting a security threat initiated by a local-network host at a local-network honeypot entity, a unit or means for triggering a threat response operation at a local-network backend entity upon detection of the security threat by the local-network honeypot entity, and a unit or means for executing the threat response operation by the local-network backend entity, said threat response operation including an operation of one of an endpoint threat management system and a local-network vulnerability management system.

An apparatus according to exemplifying embodiments of the present invention, which represents the (a part of the) honeypot entity, may comprise (at least) a unit or means for detecting a security threat initiated by a local-network host, and a unit or means for triggering a threat response operation at a local-network backend entity upon detection of the security threat.

An apparatus according to exemplifying embodiments of the present invention, which represents the (a part of the) backend entity, may comprise (at least) a unit or means for receiving a trigger for a threat response operation from a local-network honeypot entity (for responding to a security threat initiated by a local-network host at the local-network honeypot entity), and a unit or means for executing the threat response operation, said threat response operation including an operation of one of an endpoint threat management system and a local-network vulnerability management system.

For further details regarding the operability/functionality of the individual elements according to exemplifying embodiments of the present invention, reference is made to the above description in connection with any one of FIGS. 1 to 4, respectively.

According to exemplifying embodiments of the present invention, any one of the processor, the memory and the interface may be implemented as individual modules, chips, chipsets, circuitries or the like, or one or more of them can be implemented as a common module, chip, chipset, circuitry or the like, respectively.

According to exemplifying embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units, means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible or non-transitory medium such as a computer-readable (storage) medium having stored thereon a respective data structure or code means/portions or embodied in a signal or in a chip, potentially during processing thereof. A computer program product encompasses a computer memory encoded with executable instructions representing a computer program for operating/driving a computer connected to a network.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for enabling advanced local-network threat response. Such measures could exemplarily comprise detecting a security threat initiated by a local-network host at a local-network honeypot entity, triggering a threat response operation at a local-network backend entity upon detection of the security threat by the local-network honeypot entity, and executing the threat response operation by the local-network backend entity, said threat response operation including an operation of one of an endpoint threat management system and a local-network vulnerability management system.

Even though the invention is described above with reference to the examples and exemplifying embodiments with reference to the accompanying drawings, it is to be understood that the present invention is not restricted thereto. Rather, it is apparent to those skilled in the art that the above description of examples and exemplifying embodiments is for illustrative purposes and is to be considered to be exemplary and non-limiting in all respects, and the present invention can be modified in many ways without departing from the scope of the inventive idea as disclosed herein.

1. A method of local-network threat response, the method comprising:
detecting a security threat initiated by a local-network host at a local-network honeypot entity,
triggering a threat response operation at a local-network backend entity upon detection of the security threat by the local-network honeypot entity, and
executing the threat response operation by the local-network backend entity, said threat response operation including an operation of one of an endpoint threat management system and a local-network vulnerability management system.

2. The method according to claim 1, wherein said detecting comprises:
identifying an abnormal local-network activity, and
identifying the IP address of the local-network host initiating the identified abnormal local-network activity.

3. The method according to claim 2, said abnormal local-network activity including at least one of predefined connection establishment, predefined authentication attempt and malware upload or installation.

4. The method according to claim 1, wherein said triggering comprises:
transferring information on at least the IP address of the local-network host initiating the detected security threat from the local-network honeypot entity to the local-network backend entity.

5. The method according to claim 1, wherein said executing comprises:
determining whether the local-network host initiating the detected security threat is registered in the endpoint threat management system, and
executing the operation of the endpoint threat management system if the local-network host is determined to be registered in the endpoint threat management system, or executing the operation of the local-network vulnerability management system if the local-network host is determined not to be registered in the endpoint threat management system.

6. The method according to claim 5, wherein
the local-network host is determined to be registered in the endpoint threat management system when an endpoint agent is installed thereon.

7. The method according to claim 1, wherein said operation of the endpoint threat management system comprises:
causing information retrieval for retrieving information for the local-network host by activating a check and/or extraction by an endpoint agent installed on the local-network-host.

8. The method according to claim 7, said information including at least one of: information on properties of the local-network host, information on properties of the detected security threat, a memory dump, at least one file hash, at least one meta information on ongoing processes and/or connections, at least one copy of a binary, and at least one network interface data dump.

9. The method according to claim 1, said operation of the local-network vulnerability management system comprising:
causing information retrieval for retrieving information for the local-network host by performing a lookup from a local-network vulnerability database.

10. The method according to claim 1, wherein said operation of the local-network vulnerability management system comprises:
causing information retrieval for retrieving information for the local-network host by performing a scan of the local-network host, said information including at least one of: information on properties of the local-network host and information on properties of the detected security threat, system type, at least one opened port, at least one ongoing service, at least one system version, and at least one security vulnerability.

11. The method according to claim 1, wherein said operation of the endpoint threat management system comprises:
blocking or isolating the local-network host on local-network level, and/or
blocking or isolating at least one process of the local-network host relating to the detected security threat.

12. An apparatus, comprising
a memory configured to store computer program code, and
a processor configured to read and execute computer program code stored in the memory,
wherein the processor is configured to cause the apparatus to perform:
detecting a security threat initiated by a local-network host at a local-network honeypot entity,
triggering a threat response operation at a local-network backend entity upon detection of the security threat by the local-network honeypot entity, and
executing the threat response operation by the local-network backend entity, said threat response operation including an operation of one of an endpoint threat management system and a local-network vulnerability management system.

13. The apparatus according to claim 12, wherein the processor is configured to cause the apparatus, for said detecting, to perform:
identifying an abnormal local-network activity, and
identifying the IP address of the local-network host initiating the identified abnormal local-network activity.

14. The apparatus according to claim 13, wherein said abnormal local-network activity includes at least one of: predefined connection establishment, predefined authentication attempt and malware upload or installation.

15. The apparatus according to claim 12, wherein the processor is configured to cause the apparatus, for said triggering, to perform:
transferring information on at least the IP address of the local-network host initiating the detected security threat from the local-network honeypot entity to the local-network backend entity.

16. The apparatus according to claim 12, wherein the processor is configured to cause the apparatus, for said executing, to perform:
determining whether the local-network host initiating the detected security threat is registered in the endpoint threat management system, and
executing the operation of the endpoint threat management system if the local-network host is determined to be registered in the endpoint threat management system, or executing the operation of the local-network vulnerability management system if the local-network host is determined not to be registered in the endpoint threat management system.

17. The apparatus according to claim 12, wherein said operation of the endpoint threat management system comprises:
causing information retrieval for retrieving information for the local-network host by activating a check and/or extraction by an endpoint agent installed on the local-network host, said information including at least one of: information on properties of the local-network host and information on properties of the detected security threat, a memory dump, at least one file hash, at least one meta information on ongoing processes and/or connections, at least one copy of a binary, and at least one network interface data dump.

18. The apparatus according to claim 12, wherein said operation of the local-network vulnerability management system comprises:
causing information retrieval for retrieving information for the local-network host by performing at least one of: a lookup from a local-network vulnerability database, a scan of the local-network host, said information including at least one of: information on properties of the local-network host and information on properties of the detected security threat, system type, at least one opened port, at least one ongoing service, at least one system version, and at least one security vulnerability.

19. The apparatus according to claim 12, wherein said operation of the endpoint threat management system comprises:
blocking or isolating the local-network host on local-network level, and/or
blocking or isolating at least one process of the local-network host relating to the detected security threat.

20. A non-transitory computer storage medium having stored thereon a computer program code for implementing the method of claim 1.
